(19) United States
(12) Patent Application Publication
(10) Pub. No.: US 2021/0284062 A1
(43) Pub. Date: Sep. 16, 2021

(54) VEHICLE LIGHT

(71) Applicant: DAIMLER AG, Stuttgart (DE)

(72) Inventors: Moritz BRUNSCHIER, Stuttgart (DE); Wilhelmus KOK, Weinstadt (DE)

(21) Appl. No.: 17/273,892

(22) PCT Filed: Sep. 5, 2019
(86) PCT No.: PCT/EP2019/073741

§ 371 Date: Mar. 5, 2021

(30) Foreign Application Priority Data
Sep. 7, 2018 (DE) 10 2018 007 092.2

(51) Int. Cl. B60Q 1/52; B60Q 1/00; B60Q 1/30

(52) U.S. Cl. CPC B60Q 1/52; B60Q 2900/30; B60Q 1/305; B60Q 1/0023

(57) ABSTRACT

A vehicle light having at least one luminant and a cable-free interface for controlling the luminant via an integrated control device. The vehicle light includes an additional cable-bound communication and energy supply interface for controlling the luminant via the integrated control device, an energy storage device for supplying energy in the cable-free region, at least one integrated sensor for detecting vehicle states and/or the function of the cable-bound interface, and having an evaluation device for evaluating the data of the at least one sensor and for generating control signals for the control device from this.

### BACKGROUND AND SUMMARY OF THE INVENTION

Exemplary embodiments of the invention relate to a vehicle light having at least one luminant and a cable-free interface for controlling the luminant via an integrated control device.

Such a vehicle light is fundamentally known from EP 3 324 710 A1. The intension for use of a cable-free interface here primarily lies in that a cable-bound interface leads to considerable effort with the already complex cable trees in vehicles when complex light functions in the lights are to be controlled. In order to correspondingly spare this effort, EP 3 324 710 A1 thus proposes a cable-free connection for controlling the vehicle light, which is still supplied with electrical power in parallel to this via a cable connection.

US 2016/0023588 A1 describes the generic prior art.

Furthermore, in relation to further prior art, reference can be made to US 2018/0015874 A1.

Exemplary embodiments of the present invention are directed to developing a vehicle light, for example in the form of a light module or taillight module, in relation to this prior art in order to make the construction flexible and safer in terms of traffic safety, in particular also for operation in autonomous or partially autonomous vehicles and cabs.

The vehicle light according to the invention has at least one luminant and, comparable to the vehicle light described in the prior art mentioned above, one cable-free interface for controlling the luminant via a control device integrated in the vehicle light. The vehicle light according to the invention includes an additional cable-bound interface for communication, energy supply and for control. The cable-bound interface for communication and energy supply thus serves as one of the interfaces and is redundantly supplemented with the cable-free interface, which is why, according to the invention, an energy storage device is provided for supplying the vehicle light according to the invention in the cable-free operation. This energy storage device can be charged in the cable-bound operation, for example, and then provides a sufficient amount of energy for operating the cable-free interface on the one hand and for controlling the luminants, which can be formed as light-saving LED luminants, for example.

Furthermore, it is such that the vehicle light according to the invention has at least one integrated sensor for detecting vehicle states and/or the function of the cable-bound interface. In addition, an evaluation device is provided for evaluating the data of the at least one sensor and for generating control signals for the control device from this. The vehicle light according to the invention thus has a redundant control and an individual evaluation device and thus a kind of individual “intelligence”. It can evaluate vehicle states or at least the function of the cable-bound interface. If it results in certain vehicle states, such as a delay of the vehicle, for example, then a brake light, for example, when used as a taillight, can be individually activated via the vehicle light according to the invention, which reduces the control effort and enables a quick response. Moreover, the sensor system, which detects the function of the cable-bound interface, for example, also enables the possibility of a high degree of driving safety, since the cable-free transfer can be chosen, for example in the event of a malfunction of the cable-bound interface, for example because a cable is separated or detached. Should this also malfunction, for example when the vehicle light is used as a taillight in a cab in which the trailer or semitrailer has detached from the towing vehicle, then this can also be detected. In this case, the driving situation is correspondingly estimated via the evaluation device, and the following traffic can be informed and warned by activating the warning indicator light. This is a crucial advantage, in particular with partially or completely autonomously driving vehicles or vehicle cabs. With a conventional vehicle cab with a driver, in such a case the driver would be able to deploy warning lights behind the detached trailer. With the autonomously driving vehicle, this is not possible. In order to nevertheless ensure the safety, it can be achieved via the vehicle light according to the invention, which correspondingly recognizes the vehicle state, that a warning to the following traffic participants is automatically issued by e.g., the warning indicator light on the detached trailer being automatically activated.

According to an advantageous development as the individual lighting module, the vehicle light according to the invention can be equipped with driving direction indicators, illumination, and, in the case of taillights, a brake light. The individual lighting module can be used exchangeably between different vehicles in variants that are otherwise similar in terms of construction. Thus, a plurality of vehicles, trailers or semitrailers can be illuminated via a standardized module. When plugging in and connecting the trailer or semitrailer to the towing vehicle, the cable connection is then created. Should this be defective, the control of the taillight or the taillight module can be carried out via the redundant cable-free connection. Should this lead to a total detachment of the trailer or semitrailer, for example, from the towing vehicle and thus, in the end, the cable-free communication as well when the vehicle is moving away, the emergency functionality described above would take effect.

As already mentioned, the illumination can here be formed to be controllable depending on the sensor data, such that accelerations, brightnesses, yaw rates or also positional data determined via GPS can be assessed in comparison to map data, which is stored or transferred from the vehicle, and can be used to control the illumination.

The cable-free channel constructed in parallel to the cable-bound channel can be achieved by established connection technologies, for example via DSRC (Dedicated Short Range Communication) or also radio connections such as Bluetooth, Wi-Fi or similar, for example.

An exceptionally favorable development of the vehicle light according to the invention furthermore provides that the communication between vehicle and vehicle light is formed bidirectionally. In particular, in combination with the evaluation of the data of the sensors, this can be a crucial advantage, since individual transfer channels, be that cable-bound or cable-free, can be used in order to inform the vehicle, for example the towing vehicle with a cab, about the state of the taillight or the taillight module and its attachment. Thus, it can also be detected for the vehicle that a wiring of the cable-bound interface, for example, is malfunctioning or similar. Moreover, information about the vehicle light itself, in particular when this is used as a taillight on a trailer or semitrailer, can deliver possible information about the semitrailer, for example that it is moving with different acceleration or yaw rates than is to be expected with the movement of the vehicle. In particular, with partially or completely autonomously operating vehicles or vehicle trailers, this information is a valuable support for controlling the journey on one hand and for maintaining the safety aspects, in the event of unexpected movements of the trailer or semitrailer caused by an accident, for example, on the other hand.

According to an advantageous development of the invention, in the event of the loss of communication via the cable-bound interface, the possibility also then emerges from this bidirectional communication of generating a warning message. In principle, as already mentioned above, this can be generated exclusively in the region of the taillight, in order to warn the traffic behind. In the case of the bidirectional communication, it can additionally also be generated in the vehicle itself, in order to inform a person driving the vehicle or an autonomous control system in the vehicle about the malfunction, such that corresponding measures can be undertaken as needed. Furthermore, it is such that, at least in the case of the loss of communication via both interfaces, a warning light function can be activated. On the one hand, this applies to the vehicle light according to the invention in this embodiment, yet on the other hand can also be carried out on further illumination devices of the vehicle or vehicle trailer, such that, in the event of a detached trailer, for example, not only the trailer itself gives off a warning signal, but rather also the towing vehicle possibly already standing further away, in order to ideally warn further traffic participants.

As already mentioned above, a particularly preferred use of the vehicle light can here be realized as a taillight, or as an individual standardized taillight, for example, that can be used in any vehicles.

A particularly favorable development of the use provides that the taillight or the taillight module can be used as the taillight for a trailer or semitrailer of a cab or articulated vehicle, since here the safety advantages described above, in particular, are particularly significant. This applies, in particular, with at least partially, yet in particular completely, autonomously driving vehicles or cabs, such that eventually a very preferred use for the vehicle light according to the invention lies in its use as a vehicle light, and here in particular in turn as a taillight, on an autonomously driving vehicle or, preferably, vehicle cabs.

Advantageous embodiments and designs of the idea also emerge from the exemplary embodiment which is described in more detail below with reference to the figures.

### BRIEF DESCRIPTION OF THE DRAWING FIGURES

Here are shown:

FIG. 1 a vehicle cab indicated in principle with a vehicle light according to the invention; and

FIG. 2 a schematic view of a vehicle light according to the invention.

### DETAILED DESCRIPTION

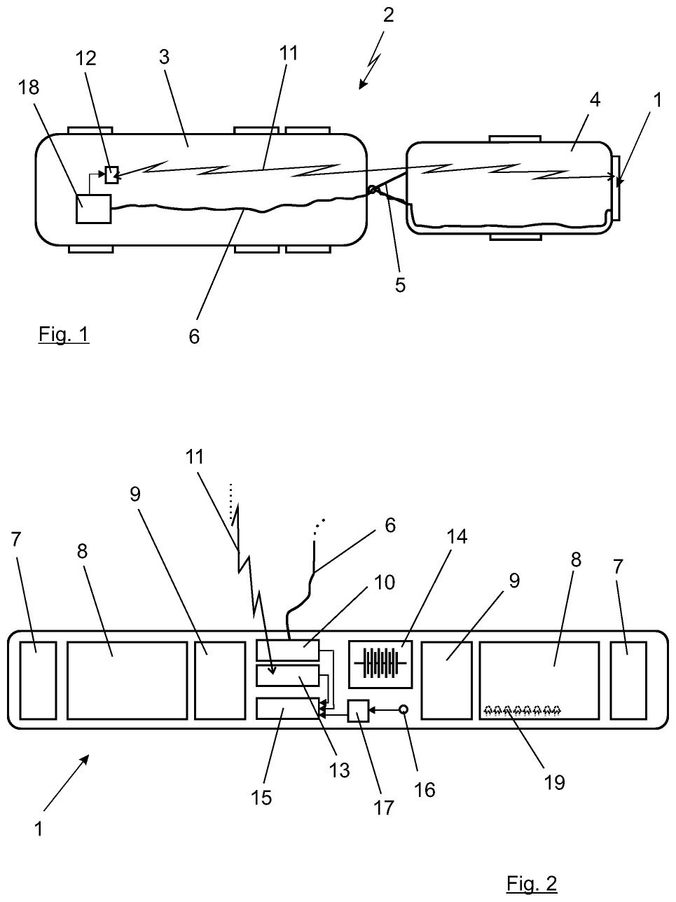

The vehicle light 1 according to the invention is designed and described in the figures below and in the exemplary embodiment below respectively as a taillight or a standardized taillight module. However, the invention is not limited to a taillight. The description by means of a vehicle cab 2 depicted in FIG. 1 also does not limit the invention to such a vehicle cab. Instead, the taillight 1 according to the invention can be used in different automatically driven or non-driven vehicles.

In the depiction of FIG. 1, a vehicle cab 2 can be seen. It consists of a towing vehicle 3 and a trailer 4. The construction is here depicted as a vehicle cab 2 with a drawbar 5 between the towing vehicle 3 and the trailer 4. The vehicle cab 2 could just as well be a so-called articulated truck, with a semitrailer attached directly to the towing vehicle 3 instead of the trailer 4, without thus changing the meaning below.

A taillight module 1 is attached to the trailer 4, which module forms the taillight 1 of the trailer 4 and which can be designed as an individual standardized module, yet does not have to be.

The module of the vehicle light 1 referred to below as the taillight 1 is correspondingly connected in an inherently known manner via a cable connection 6, such as typically a plug connection between the trailer 4 and the vehicle 3, and, inside the respective part of the towing vehicle 3 and trailer 4, via a cable tree. In doing so, the energy supply and the supply with control data, for example to control the driving direction indicator 7 indicated in FIG. 2, are transmitted in the normal operation. Along with the driving direction indicators 7, in the depiction of FIG. 2, rear lights 8 and brake lights 9 are indicated by way of example. As luminants 19, LEDs, for example, can be used therein, as indicated in one of the rear lights 8. In principle, further elements such as a rear driving light or similar are naturally also conceivable. In addition to and redundantly to the connection via the cable 6, which is in connection with a corresponding interface 10 with the taillight 1, there is, moreover, a wireless communication connection, which is respectively indicated in the depictions of FIGS. 1 and 2 with 11. The wireless connection functions via a wireless communication module 12 in the towing vehicle 3 and a cable-free interface 13 in the taillight 1. Various technologies can be used here, for example Bluetooth, Wi-Fi, DSRC or other established methods for the wireless transmission of data over typically short distances.

The wireless connection 11 along with the cable connection 6 functions substantially in parallel, such that there is a redundancy. In addition, electrical power can be transmitted via the cable connection 6, which is indeed possible in principle via the wireless connection, yet in practice is rather laborious. The taillight 1 thus has an energy storage device 14, for example an accumulator, in order to be able to be charged while the cable 6 is attached and to be able to assume the energy provision of the taillight 1 when the cable 6 is not attached or is defective.

Both the cable-bound interface 10 and the cable-free interface 13 here have an effect on a control device 15 in the taillight 1, which is designed to control the actual light functions. This could just as well be integrated into one or both of the interfaces 10, 13 or have one or both of the interfaces 10, 13 integrated in it. Furthermore, at least one sensor 16 and an evaluation device 17 is present for the data received from the sensor 16, such that the taillight 1 has a certain individual “intelligence”. Vehicle states of the trailer 4, for example, can be determined via this by, for example, yaw rates, accelerations or even vehicle positions by means of GPS data, speeds or similar being evaluated. Various light functionalities can be controlled via the individual intelligence independently of a control by the towing vehicle 3, for example a brake light or similar in the case of a delay.

The particular advantage of the redundant design of the cable-bound connection via the cable 6 and the wireless connection 11 in parallel to one another lies in that, furthermore, a safe functionality is ensured in the event of one of the two connections malfunctioning. This is particularly advantageous when it can lead to problems in the region of the cable connection, for example a detachment of the cable connection or the plug connection in the region of the drawbar 5 or, in the worst case, to a detachment of the entire trailer at the drawbar 5 from the towing vehicle 3. In this case, the cable connection would completely malfunction. From the point of view of the towing vehicle 3, even if the detachment were to be detected there, a warning function could no longer be activated in the vehicle light 1 as the taillight, since the connection does not exist. Furthermore, this could be carried out via the cable-free connection, such that, in such a case, the driving direction indicators 7, for example, could be activated as the flashing warning light. If the cable-free connection 11 also detaches, then, as a result of the individual intelligence of the vehicle 1, this can also notice the detachment and activate the flashing warning function automatically via the evaluation device 17, for example, when the problem is detected.

With a bidirectional communication between the taillight 1 and the towing vehicle 3 or the controller 18 schematically indicated there, it would now moreover be conceivable to emit a corresponding warning to the towing vehicle 3, at least as long as the wireless connection 11 still exists, such that it can stop, for example.

Here, the whole scenario is of great interest, in particular with completely autonomously driving vehicles 2, since it here increases traffic safety as a result of the additional redundancy and creates the possibility of warning other traffic participants, which would thus otherwise not be possible with autonomously driving vehicles 2. However, also with vehicles 2 controlled completely or partially by a driver, this can be a considerable advantage, since the flashing warning system for warning following traffic participants can be activated much more quickly in the event of the trailer 4 detaching, before the incident has been noticed by the driver, they have stopped the towing vehicle 3 and have manually positioned corresponding warning lights behind the trailer 4. All in all, such a construction of the vehicle light 1, in particular in terms of its design as a taillight, thus considerably contributes to an increase of safety.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-8. (canceled)

9. A vehicle light for a vehicle, comprising:
at least one luminant;
a cable-free interface configured to control the at least one luminant via an integrated control device;
a cable-bound communication and energy supply interface configured to control the at least one luminant via the integrated control device;
an energy storage device configured to supply energy to the vehicle light;
at least one integrated sensor configured to detect vehicle states or a function of the cable-bound communication and energy supply interface;
an evaluation device configured to evaluate data of the at least one sensor and configured to generate control signals for the control device the evaluated data,
wherein the at least one integrated sensor is configured to detect at least the function of the cable-bound communication and energy supply interface,
wherein, in event of a loss of cable-bound communication via the cable-bound communication and energy supply interface, a warning message is generated,
wherein, in event of a malfunction of the cable-bound communication via the cable-bound communication and energy supply interface, communication with the vehicle light is performed using cable-free communication via the cable-free interface, and
wherein, in event of additional loss of the cable-free communication via the cable-free interface, at least one warning light function is activated.

10. The vehicle light of claim 9, wherein the vehicle light is an individual module with at least one driving direction indicator and at least one illumination.

11. The vehicle light of claim 9, wherein the at least one luminant is controlled depending on the sensor data.

12. The vehicle light of claim 9, wherein the cable-free interface is a DSRC, Wi-Fi, Bluetooth, or radio interface.

13. The vehicle light of claim 9, wherein communication between the vehicle and the vehicle light is bidirectional.

14. The vehicle light of claim 9, wherein the vehicle light is a taillight for a trailer, semitrailer of a cab, or articulated vehicle.

15. The vehicle light of claim 14, wherein the vehicle or the cab is a completely autonomously driving vehicle or cab.

16. A method for controlling a vehicle light of a vehicle, the vehicle light including at least one luminant, the method comprising:
controlling, by a cable-free interface, the at least one luminant via an integrated control device;
controlling and supplying energy to the at least one luminant by a cable-bound communication and energy supply interface via the integrated control device;
supplying, by an energy storage device, energy to the vehicle light;
detecting, by at least one integrated sensor, vehicle states or a function of the cable-bound communication and energy supply interface;
evaluating, by an evaluation device, data of the at least one sensor and generating control signals for the control device the evaluated data,
detecting, by the at least one integrated sensor, at least the function of the cable-bound communication and energy supply interface;
generating, in event of a loss of cable-bound communication via the cable-bound communication and energy supply interface, a warning message;
performing communications with the vehicle light using cable-free communication via the cable-free interface in event of a malfunction of the cable-bound communication via the cable-bound interface;
activating at least one warning light function in event of additional loss of the cable-free communication via the cable-free interface.

17. The method of claim 16, wherein the at least one luminant is controlled depending on the sensor data.

18. The method of claim 16, wherein the cable-free interface is a DSRC, Wi-Fi, Bluetooth, or radio interface.

19. The method of claim 16, wherein communication between the vehicle and the vehicle light is bidirectional.
